(19) United States
(12) Patent Application Publication
(10) Pub. No.: US 2022/0231285 A1
(43) Pub. Date: Jul. 21, 2022

(54) SOLID-STATE SECONDARY BATTERY

(71) Applicant: SEMICONDUCTOR ENERGY LABORATORY CO., LTD., ATSUGI-SHI, KANAGAWA-KEN (JP)

(72) Inventors: Kazutaka KURIKI, Ebina, Kanagawa (JP); Ryota TAJIMA, Isehara, Kanagawa (JP); Yumiko YONEDA, Isehara, Kanagawa (JP)

(21) Appl. No.: 17/617,188

(22) PCT Filed: Jun. 1, 2020
(86) PCT No.: PCT/IB2020/055155

§ 371 Date: Dec. 7, 2021

(30) Foreign Application Priority Data
Jun. 12, 2019 (JP) 2019-109230

(51) Int. Cl. H01M 4/36; H01M 4/525

(52) U.S. Cl. CPC H01M 4/366; H01M 2004/028; H01M 4/525

(57) ABSTRACT

A solid-state secondary battery with high charge and discharge characteristics is provided. The solid-state secondary battery includes a first layer and a positive electrode active material layer over a substrate. The first layer and the positive electrode active material layer are in contact with each other; the first layer has conductivity; the first layer has a first crystal structure including first cations and first anions; the positive electrode active material layer has a second structure including second cations and second anions; and a value calculated by the following formula (1) is less than or equal to 0.1 when La denotes the minimum value of a distance between one of the first cations and another one of the first cations in the first crystal structure and Lb denotes the minimum value of a distance between one of the second cations and another one of the second cations.

$$\frac{\vert La - Lb \vert}{L a} \qquad ( 1 )$$

### TECHNICAL FIELD

One embodiment of the present invention relates to an object, a method, or a manufacturing method. Alternatively, the present invention relates to a process, a machine, manufacture, or a composition (composition of matter). One embodiment of the present invention relates to a semiconductor device, a display device, a light-emitting device, a power storage device, a lighting device, an electronic device, or a forming method thereof.

Note that electronic devices in this specification generally mean devices including power storage devices, and electro-optical devices including power storage devices, information terminal devices including power storage devices, and the like are all electronic devices.

### BACKGROUND ART

Electronic devices carried around by users and wearable electronic devices have been actively developed.

A primary battery or a secondary battery which is an example of a power storage device functions as an electronic device carried around by users or a power supply of a wearable electronic device. The electronic devices carried around by users need to withstand the use for a long period, and high-capacity secondary batteries are used. However, there is a problem in that high-capacity secondary batteries are large and have a heavy weight. In view of the problem, development of small or thin high-capacity secondary batteries that can be incorporated in portable electronic devices is being pursued.

In lithium-ion secondary batteries generally available, an electrolyte solution such as an organic solvent is used as a medium for transporting lithium ions that are carrier ions. However, a secondary battery using liquid has problems such as the operable temperature range, decomposition reaction of an electrolyte solution due to a potential to be used, and liquid leakage to the outside of the secondary battery since the secondary battery uses liquid. In addition, a secondary battery using an electrolyte solution has a risk of ignition due to liquid leakage.

As a secondary battery using no liquid, a power storage device using a solid electrolyte, which is called a solid-state battery, is known. For example, Patent Document 1 is disclosed. Moreover, Patent Document 2 discloses a solid-state secondary battery using graft polymer.

### PRIOR ART

[Patent Document]

[Patent Document 1] U.S. Pat. No. 8,404,001 [Patent Document 2] Japanese Published Patent Application No. 2011-014387

### SUMMARY OF THE INVENTION

### Problems to be Solved by the Invention

In thin-film-type solid-state secondary batteries (also referred to as thin-film-type all-solid-state batteries), there is room for improvements in a variety of aspects such as charge and discharge characteristics, cycle characteristics, reliability, safety, and costs. For example, as a method for increasing the charge and discharge capacity of a thin-film-type all-solid-state battery, an increase in the crystallinity of a positive electrode active material layer can be given. Thermal treatment at high temperatures or the like can be given as a method for increasing the crystallinity; however, the thermal treatment is sometimes difficult depending on a material of a positive electrode current collector or a substrate.

In view of the above, an object of one embodiment of the present invention is to provide a solid-state secondary battery with large charge and discharge capacity. Another object of one embodiment of the present invention is to provide a solid-state secondary battery with excellent cycle characteristics. Another object of one embodiment of the present invention is to provide a novel all-solid-state secondary battery with a higher level of safety than conventional lithium ion secondary batteries using an electrolyte solution. Another object of one embodiment of the present invention is to provide a novel power storage device.

Note that the description of these objects does not preclude the existence of other objects. One embodiment of the present invention does not have to achieve all these objects. Other objects can be derived from the description of the specification, the drawings, and the claims.

### Means for Solving the Problems

One embodiment of the present invention is a solid-state secondary battery including a first layer and a positive electrode active material layer over a substrate. The first layer and the positive electrode active material layer are in contact with each other; the first layer has conductivity; the first layer has a first crystal structure including first cations and first anions; the positive electrode active material layer has a second crystal structure including second cations and second anions; and a value calculated by the following formula (1) is less than or equal to 0.1 when La denotes the minimum value of a distance between one of the first cations and another one of the first cations in the first crystal structure and Lb denotes the minimum value of a distance between one of the second cations and another one of the second cations in the second crystal structure.

$$\begin{matrix}[ Formula 1 ] & \\ \frac{\vert La - Lb \vert}{L a} & ( 1 )\end{matrix}$$

One embodiment of the present invention is a solid-state secondary battery including a first layer and a positive electrode active material layer over a substrate. The first layer and the positive electrode active material layer are in contact with each other; the first layer has conductivity; the first layer has a first crystal structure including first cations and first anions; the positive electrode active material layer has a second crystal structure including second cations and second anions; and a value calculated by the following formula (2) is less than or equal to 0.1 when La denotes the minimum value of a distance between one of the first cations and another one of the first cations in the first crystal structure and Lb denotes the minimum value of a distance between one of the second cations and another one of the second cations in the second crystal structure.

$$\begin{matrix}[ Formula 2 ] & \\ \frac{\vert la - lb \vert}{la} & ( 2 )\end{matrix}$$

In the above structure, the second cations preferably include a transition metal.

In the above structure, the minimum angle formed by the first cation and the first anion is preferably greater than or equal to 85° and less than or equal to 90°, and the minimum angle formed by the second cation and the second anion is preferably greater than or equal to 85° and less than or equal to 90°.

In the above structure, the first crystal structure is preferably a rock-salt crystal structure, and the second crystal structure is a layered rock-salt crystal structure.

In the above structure, the substrate and the first layer preferably include the same metal.

In the above structure, a positive electrode current collector layer is preferably included between the substrate and the first layer, and it is further preferable that the positive electrode current collector and the first layer include the same metal.

In the above structure, the positive electrode active material layer preferably includes a lithium cobaltate.

In the above structure, the first layer preferably includes a titanium nitride.

### Effect of the Invention

According to one embodiment of the present invention, a solid-state secondary battery with high charge and discharge capacity can be provided. According to another embodiment of the present invention, a solid-state secondary battery with excellent cycle characteristics can be provided. According to another embodiment of the present invention, a novel all-solid-state secondary battery with a higher level of safety than a conventional lithium-ion secondary battery using an electrolyte solution can be provided. According to another embodiment of the present invention, a novel power storage device can be provided.

The capacity of the thin-film-type solid-state secondary battery can also be made higher by an increase in the area.

Furthermore, by a separation transfer technology, bending into a desired size can be performed after the area is increased.

### BRIEF DESCRIPTION OF THE DRAWINGS

FIG. 1A and FIG. 1B are cross-sectional views each illustrating one embodiment of the present invention.

FIG. 2A is a diagram showing a crystal structure of titanium nitride, and FIG. 2B is a diagram showing a crystal structure of LiCoO₂.

FIG. 3A, FIG. 3B, and FIG. 3C are cross-sectional views each illustrating one embodiment of the present invention.

FIG. 4A and FIG. 4B are a top view and a cross-sectional view illustrating one embodiment of the present invention.

FIG. 5 is a diagram showing a manufacturing flow of a solid-state secondary battery of one embodiment of the present invention.

FIG. 6A and FIG. 6B are top views each illustrating one embodiment of the present invention.

FIG. 7 is a cross-sectional view illustrating one embodiment of the present invention.

FIG. 8 is a diagram showing a manufacturing flow of a solid-state secondary battery of one embodiment of the present invention.

FIG. 9 is a schematic top view of a manufacturing apparatus for a solid-state secondary battery.

FIG. 10 is a cross-sectional view of part of a manufacturing apparatus for a solid-state secondary battery.

FIG. 11A is a perspective view illustrating an example of a battery cell, FIG. 11B is a perspective view of a circuit, and FIG. 11C is a perspective view of the case where the battery cell and the circuit are stacked.

FIG. 12A is a perspective view illustrating an example of a battery cell, FIG. 12B is a perspective view of a circuit, and FIG. 12C and FIG. 12D are each a perspective view of the case where the battery cell and the circuit are stacked.

FIG. 13A is a perspective view of a battery cell, and FIG. 13B is a diagram illustrating an example of an electronic device.

FIG. 14A, FIG. 14B, and FIG. 14C are drawings illustrating examples of electronic devices.

FIG. 15A is a schematic diagram of a device showing one embodiment of the present invention,

FIG. 15B is a diagram illustrating part of a system, and FIG. 15C is an example of a perspective view of a portable data terminal used with the system.

FIG. 16 is a graph showing XRD measurement results of samples in Example.

FIG. 17A and FIG. 17B are graphs showing charge and discharge characteristics of solid-state secondary batteries in Example.

### MODE FOR CARRYING OUT THE INVENTION

Embodiments of the present invention are described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

The Miller index is used for the expression of crystal planes and orientations in this specification and the like. An individual plane representing a crystal plane is denoted by “( )”.

### Embodiment 1

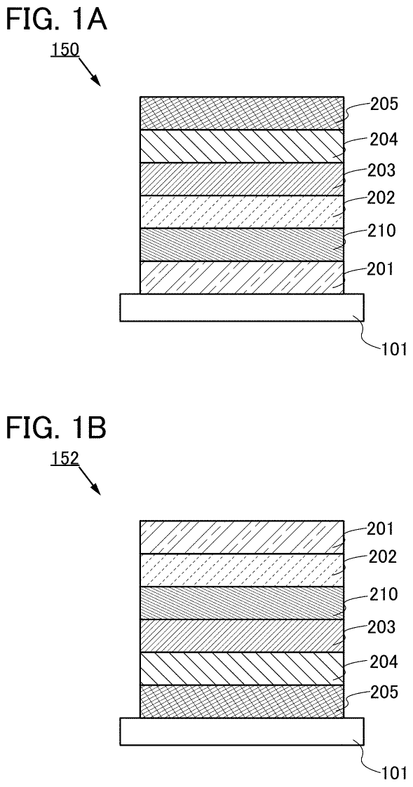

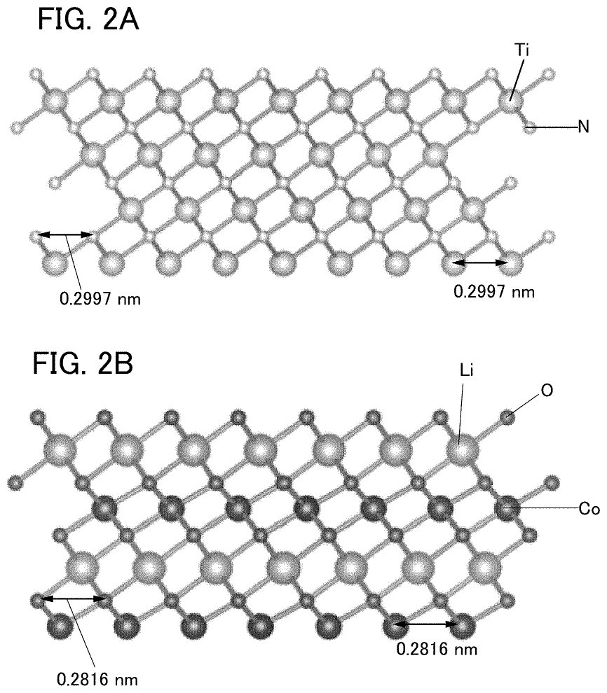

A solid-state secondary battery of one embodiment of the present invention will be described with reference to FIG. 1A, FIG. 1B, FIG. 2A, and FIG. 2B.

### Structure Example 1 of Solid-State Secondary Battery

A solid-state secondary battery 150 illustrated in FIG. 1A and FIG. 1B includes at least a positive electrode current collector layer 201, a base film 210, a positive electrode active material layer 202, a solid electrolyte layer 203, a negative electrode active material layer 204, and a negative electrode current collector layer 205 in this order over a substrate 101.

Since the crystallinity of a positive electrode active material layer affects the charge and discharge characteristics of a solid-state secondary battery, higher crystallinity of the positive electrode active material layer is preferable. In formation of a solid-state secondary battery including a positive electrode (including at least a positive electrode current collector layer and a positive electrode active material layer) on a substrate side, the following structure is assumed: the positive electrode current collector layer is formed using a material including a metal whose interatomic distance is significantly different from an interatomic distance of a transition metal in the positive electrode active material layer; and the positive electrode current collector layer and the positive electrode active material layer are in contact with each other is employed. In such a structure, the crystallinity of the positive electrode active material layer becomes low, sometimes, resulting in insufficient capacity of the solid-state secondary battery.

The inventors of the present invention found that, when a base film is formed using a material including a metal whose interatomic distance is approximately the same as an interatomic distance of a transition metal in a positive electrode active material layer, the crystallinity of the positive electrode active material layer can be enhanced, which enables an improvement in the charge and discharge characteristics of a solid-state secondary battery.

In the solid-state secondary battery of one embodiment of the present invention, the base film 210 is introduced between the positive electrode current collector layer 201 and the positive electrode active material layer 202 so as to be in contact with the positive electrode active material layer 202. For the base film 210, a material including a metal whose interatomic distance is approximately the same as the interatomic distance of a transition metal in the positive electrode active material layer 202 is used. The positive electrode active material layer 202 is formed over the base film 210, so that the formed positive electrode active material layer 202 can have substantially aligned crystal orientation. As a result, the crystallinity of the positive electrode active material layer 202 can be enhanced, and a solid-state secondary battery with excellent charge and discharge characteristics can be manufactured.

Here, the base film 210 preferably has conductivity. Having conductivity can enhance the crystallinity of the positive electrode active material layer 202 without a degradation in characteristics of the secondary battery.

When the positive electrode active material layer 202 is formed to substantially align the crystal orientation with that of the base film 210, the crystal orientation of the positive electrode active material layer 202 is substantially aligned three-dimensionally with that of the base film 210. In other words, the base film 210 and the positive electrode active material layer 202 become to exhibit topotaxy. To have the topotaxy, of importance is an interatomic distance of a metal as a material used in the base film 210 and an interatomic distance of a transition metal as a material used in the positive electrode active material layer 202.

The case considered here is that an ionic crystal A having conductivity is used for the base film 210 and an ionic crystal B is used for the positive electrode active material layer 202. For deposition of the ionic crystal B over the ionic crystal A so that their crystal orientations are substantially aligned, it is preferable that the crystal structures of the ionic crystal A and the ionic crystal B be similar to each other. Specifically, a value calculated by the following formula (1) is preferably less than or equal to 0.1, further preferably less than or equal to 0.06, where La denotes the minimum value of a distance between a cation (metal atom) and another cation (metal atom) in the ionic crystal A and Lb denotes the minimum value of a distance between a cation (transition metal atom) and another cation (transition metal atom) in the ionic crystal B.

$$\begin{matrix}[ Formula 3 ] & \\ \frac{\vert La - Lb \vert}{L a} & ( 1 )\end{matrix}$$

Note that the above La can be either a distance between cations of the same species or a distance between cations of different species, and is the minimum value of a distance between cations in an ideal crystal structure of the ionic crystal A. Similarly, the above Lb can be either a distance between cations of the same species or a distance between cations of different species, and is the minimum value of a distance between cations (transition metal) in an ideal crystal structure of the ionic crystal B.

As described above, a preferable material for the base film 210 is to have conductivity and satisfy that a value calculated by the formula (1) is less than or equal to 0.1, and a further preferable material is to have conductivity and satisfy that a value calculated by the formula (1) is less than or equal to 0.06. When lithium cobaltate is used for the positive electrode active material layer 202, it is preferable for the base film 210 to use titanium nitride (TiN), aluminum (Al), aluminum nitride (AlN), aluminum oxide (Al₂O₃), LiNbO₃, tantalum nitride (TaN), titanium oxide, Cu, and the like.

The above description focuses on La and Lb in the formula (1) so that the crystal orientations are substantially aligned with each other; instead, a distance between a cation and an anion in the ionic crystal may be focused on.

When the ionic crystal A having conductivity is used for the base film 210 and the ionic crystal B is used for the positive electrode active material layer 202, a value calculated by the following formula (2) is preferably less than or equal to 0.1, further preferably less than or equal to 0.07, where la denotes the minimum value of a distance between an anion (nonmetal atom) and another anion (nonmetal atom) in the ionic crystal A and lb denotes the minimum value of a distance between an anion (nonmetal atom) and another anion (nonmetal atom) in the ionic crystal B.

$$\begin{matrix}[ Formula 4 ] & \\ \frac{\vert la - lb \vert}{la} & ( 2 )\end{matrix}$$

A preferable material for the base film 210 is to have conductivity and satisfy that a value calculated by the formula (2) is less than or equal to 0.1, and a further preferable material is to have conductivity and satisfy that a value calculated by the formula (2) is less than or equal to 0.07. When lithium cobaltate is used for the positive electrode active material layer 202, it is preferable for the base film 210 to use titanium nitride (TiN), aluminum (Al), aluminum nitride (AlN), aluminum oxide (Al₂O₃), LiNbO₃, tantalum nitride (TaN), titanium oxide, Cu, and the like.

With an example of using titanium nitride (TiN) for the base film 210 and lithium cobaltate (LiCoO₂) for the positive electrode active material layer 202, the relation between the formula (1) and the formula (2) is described. FIG. 2A and FIG. 2B illustrate (111) of titanium nitride (of rock-salt type) and (003) of lithium cobaltate. As shown in FIG. 2A and FIG. 2B, the minimum distance between a titanium atom and another titanium atom in the titanium nitride (La in the formula (1)) is 0.2997 nm, and the distance between a cobalt atom and another cobalt atom in the lithium cobaltate (Lb in the formula (1)) is 0.2816 nm; accordingly the value calculated by the formula (1) is approximately 0.06. Thus, titanium nitride can be preferably used as the base film.

Similarly, as shown in FIG. 2A and FIG. 2B, the minimum distance between a nitrogen atom and another nitrogen atom in the titanium nitride (la in the formula (2)) is 0.2997 nm, and the minimum distance between an oxygen atom and another oxygen atom in the lithium cobaltate (lb in the formula (2)) is 0.2816 nm; accordingly the value calculated by the formula (2) is approximately 0.06. Thus, titanium nitride can be preferably used as the base film.

The above distance between atoms (ions) can be calculated by XRD measurement, electron diffraction measurement, neutron diffraction measurement, or the like.

When being deposited with the crystal orientation being substantially aligned, the base film 210 and the positive electrode active material layer 202 preferably have crystal structures similar to each other. Thus, preferable materials to be used satisfy the following: the minimum angle formed by the transition metal atom and a nonmetal atom coordinated to the transition metal atom included in the positive electrode active material layer 202 is greater than or equal to 85° and less than or equal to 90°; the minimum angle formed by the metal atom and a nonmetal atom coordinated to the metal atom included in the base film 210 is greater than or equal to 85° and less than or equal to 90°; and at least one of the values of the above formula (1) and formula (2) is less than or equal to 0.1 (further preferably less than or equal to 0.07). With use of the materials satisfying the above structure, the positive electrode active material layer 202 with high crystallinity can be obtained.

Assuming, as a crystal structure model of the above lithium cobaltate, a model where a cobalt atom that is a transition metal is coordinated to six oxygen atoms, the angle formed by the cobalt atom and the oxygen atom is supposed to be 180° and 90°. Thus, in the case of lithium cobaltate, the minimum value of an angle formed by the cobalt atom and the oxygen atom coordinated to the cobalt atom is 90°. Similarly, assuming, as a crystal structure model of titanium nitride, a model where titanium that is a metal atom is coordinated to six nitrogen atoms, the angle formed by the titanium atom and the nitrogen atom is supposed to be 180° and 90°. Thus, in the case of titanium nitride, the minimum value of an angle formed by the titanium atom and the nitrogen atom coordinated to the titanium atom is 90°.

Furthermore, when being deposited with the crystal orientation being substantially aligned, the base film 210 and the positive electrode active material layer 202 preferably have crystal structures similar to each other. Thus, it is preferable for the positive electrode active material layer 202 to use a layered rock-salt material, and it is preferable for the base film 210 to use a material having a rock-salt crystal structure. Moreover the materials preferably satisfy that at least one values of the above formula (1) and formula (2) is less than or equal to 0.1 (further preferably less than or equal to 0.07). With use of the materials satisfying the above, the positive electrode active material layer 202 with high crystallinity can be obtained. Note that the above lithium cobaltate is a material having a layered rock-salt crystal structure, and the titanium nitride is a material having a rock-salt crystal structure.

### Structure Example 2 of Solid-State Secondary Battery

FIG. 1B illustrates a solid-state secondary battery 152 different from the solid-state secondary battery 150 illustrated in FIG. 1A. The solid-state secondary battery 152 illustrated in FIG. 1B includes at least the negative electrode current collector layer 205, the negative electrode active material layer 204, the solid electrolyte layer 203, the base film 210, the positive electrode active material layer 202, and the positive electrode current collector layer 201 in this order over the substrate 101. The solid-state secondary battery 150 is a solid-state secondary battery in which a positive electrode is positioned on the substrate 101 side; the solid-state secondary battery 152 is a solid-state secondary battery in which a negative electrode (including at least the negative electrode current collector and the negative electrode active material layer) is positioned on the substrate 101 side.

In order to enhance the crystallinity of the positive electrode active material layer 202, the positive electrode active material layer 202 needs to be formed over and in contact with the base film 210. Thus, in the solid-state secondary battery 152, the positive electrode active material layer 202 is formed after the base film 210 is formed over the solid electrolyte layer 203. In other words, the base film 210 is formed between the solid electrolyte layer 203 and the positive electrode active material layer 202. With use of the ionic crystal A and the ionic crystal B, which make at least one of the values of the above formula (1) and formula (2) be less than or equal to 0.1, for the base film 210 and the positive electrode active material layer 202 respectively in the above structure, a solid-state secondary battery with favorable charge and discharge efficiency can be obtained.

### Structure Example 3 of Solid-State Secondary Battery

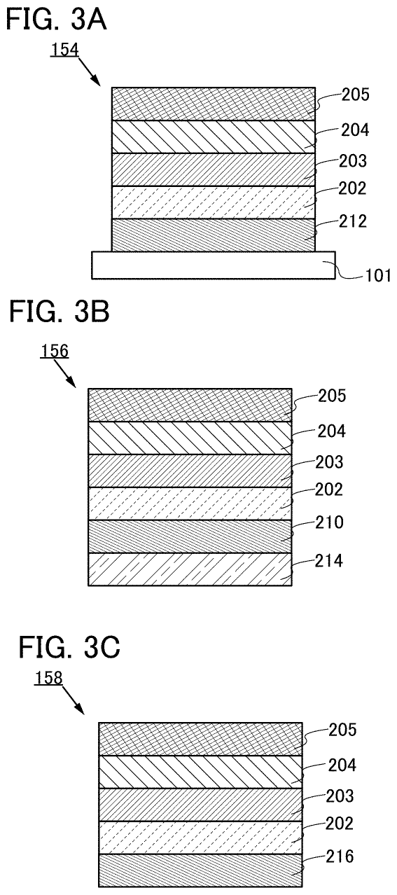

FIG. 3A, FIG. 3B, and FIG. 3C illustrate solid-state secondary batteries different from the solid-state secondary battery 150 and the solid-state secondary battery 152 illustrated in FIG. 1A and FIG. 1B.

A solid-state secondary battery 154 illustrated in FIG. 3A includes at least a positive electrode current collector layer 212, the positive electrode active material layer 202, the solid electrolyte layer 203, the negative electrode active material layer 204, and the negative electrode current collector layer 205 in this order over the substrate 101.

In the solid-state secondary battery 154, the ionic crystal A and the ionic crystal B satisfying that at least one of values calculated by the above formula (1) and formula (2) is less than or equal to 0.1 are used for the positive electrode current collector layer 212 and the positive electrode active material layer 202, respectively. Such a structure enables the positive electrode active material layer 202 with high crystallinity to be formed without a base film. Thus, a solid-state secondary battery with favorable characteristics can be manufactured easily.

A solid-state secondary battery 156 illustrated in FIG. 3B includes at least a positive electrode current collector layer 214, the base film 210, the positive electrode active material layer 202, the solid electrolyte layer 203, the negative electrode active material layer 204, and the negative electrode current collector layer 205 stacked in this order.

In the solid-state secondary battery 156, the ionic crystal A and the ionic crystal B satisfying that at least one of the values calculated by the above formula (1) and formula (2) is less than or equal to 0.1 are used for the base film 210 and the positive electrode active material layer 202, respectively. The positive electrode current collector layer 214 has a function of a positive electrode current collector and a function of a substrate. With such a structure, the positive electrode current collector layer 214 can serve as both the substrate and the positive electrode current collector, and the positive electrode active material layer 202 with high crystallinity can be fabricated. Thus, a solid-state secondary battery with favorable characteristics can be manufactured easily.

A solid-state secondary battery 158 illustrated in FIG. 3C includes at least a positive electrode current collector layer 216, the positive electrode active material layer 202, the solid electrolyte layer 203, the negative electrode active material layer 204, and the negative electrode current collector layer 205 in this order.

In the solid-state secondary battery 158, the ionic crystal A and the ionic crystal B satisfying that at least one of values calculated by the above formula (1) and formula (2) is less than or equal to 0.1 are used for the positive electrode current collector layer 216 and the positive electrode active material layer 202, respectively. The positive electrode current collector layer 216 has a function of a positive electrode current collector and a function of a substrate. Such a structure enables the positive electrode active material layer with high crystallinity to be formed without a base film. Thus, a solid-state secondary battery with favorable characteristics can be manufactured easily.

The solid-state secondary batteries 150 and 152 illustrated in FIG. 1A and FIG. 1B have an advantage of a wide selection range of positive electrode current collector materials because there is no particular limitation on materials used for the positive electrode current collector layer 201. The solid-state secondary battery 154, the solid-state secondary battery 156, and the solid-state secondary battery 158 have an advantage of easy manufacturing.

### Structure Example 4 of Solid-State Secondary Battery

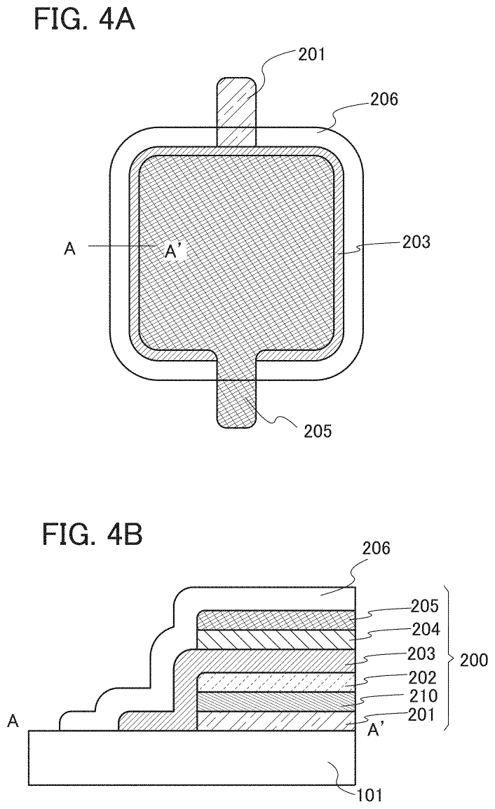

FIG. 4A and FIG. 4B illustrate a solid-state secondary battery of one embodiment of the present invention. FIG. 4A is a top view, and FIG. 4B corresponds to a cross-sectional view taken along line AA′ in FIG. 4A.

As illustrated in FIG. 4B, the positive electrode current collector layer 201 is formed over the substrate 101, and the base film 210, the positive electrode active material layer 202, the solid electrolyte layer 203, the negative electrode active material layer 204, the negative electrode current collector layer 205, and a protective layer 206 are stacked in this order over the positive electrode current collector layer 201. A single-layer cell 200 includes at least the positive electrode current collector layer 201, the positive electrode active material layer 202, the solid electrolyte layer 203, the negative electrode active material layer 204, and the negative electrode current collector layer 205. FIG. 4B illustrates a case where the base film 210 is further included.

Each of these films can be formed using a metal mask. The positive electrode current collector layer 201, the base film 210, the positive electrode active material layer 202, the solid electrolyte layer 203, the negative electrode active material layer 204, the negative electrode current collector layer 205, and the protective layer 206 may be selectively formed by a sputtering method. Furthermore, the solid electrolyte layer 203 may be selectively formed using a metal mask by a co-evaporation method.

As illustrated in FIG. 4A, part of the negative electrode current collector layer 205 is exposed to form a negative electrode terminal portion. A region of the negative electrode current collector layer 205 other than the negative electrode terminal portion is covered with the protection layer 206. In addition, part of the positive electrode current collector layer 201 is exposed to form a positive electrode terminal portion. A region of the positive electrode current collector layer 201 other than the positive electrode terminal portion is covered with the protection layer 206.

A metal oxide containing one kind or two or more kinds selected from hafnium, aluminum, gallium, yttrium, zirconium, tungsten, titanium, tantalum, nickel, germanium, neodymium, lanthanum, magnesium, and the like can be used as the protective layer 206. Alternatively, silicon nitride oxide, silicon nitride, or the like can be used. The protective layer 206 can be formed by a sputtering method.

For the single-layer cell, any of the structures of the solid-state secondary batteries 150, 152, 154, 156, and 158 with respective stacking orders can be used.

### Embodiment 2

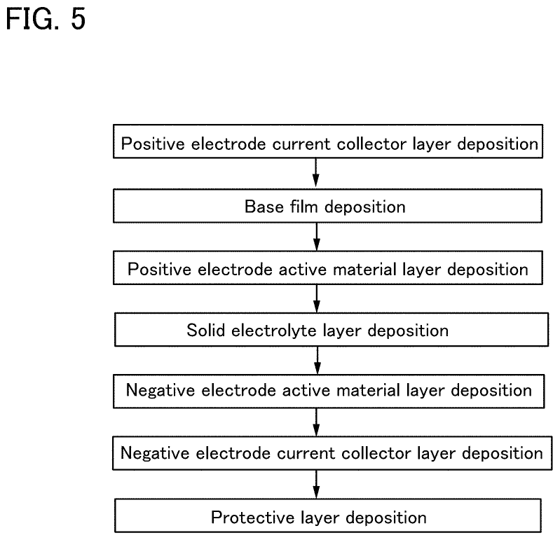

In this embodiment, a method for manufacturing the solid-state secondary battery described in Embodiment 1 will be described. FIG. 5 illustrates an example of a manufacturing flow for obtaining the structure illustrated in FIG. 4A and FIG. 4B.

First, the positive electrode current collector layer 201 is formed over the substrate. As a film-formation method, a sputtering method, an evaporation method, or the like can be used. A substrate having conductivity may be used as a current collector. The positive electrode current collector layer 201 can be formed using a material having high conductivity, such as a metal like stainless steel, gold, platinum, aluminum, or titanium, or an alloy thereof. It is preferred that a material used for the positive electrode current collector layer 201 not dissolve at the potential of the positive electrode. Alternatively, it is possible to use an aluminum alloy to which an element that improves heat resistance, such as silicon, titanium, neodymium, scandium, or molybdenum, is added. Still alternatively, a metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have any of various shapes including a foil-like shape, a plate-like shape (sheet-like shape), a net-like shape, a punching-metal shape, and an expanded-metal shape. The preferred thickness of the positive electrode current collector layer 201 to be used is greater than or equal to 5 μm and less than or equal to 30 μm. The above-described material can be also used for the positive electrode current collector layers 212, 214, and 216.

Examples of the substrate 101 include a ceramic substrate, a glass substrate, a plastic substrate, a silicon substrate, and a metal substrate.

Next, the base film 210 is formed. As a film-formation method of the base film 210, a sputtering method, an evaporation method, or the like can be used. In a sputtering method, with use of a metal mask, film deposition can be selectively performed. Alternatively, patterning may be performed on the base film 210 by selective removal due to dry etching or wet etching with use of a resist mask or the like.

The base film 210 preferably has higher crystallinity. The base film 210 needs to have a certain thickness to have high crystallinity. The thickness of the base film 210 is preferably greater than or equal to 20 nm, further preferably greater than or equal to 100 nm, and still further preferably greater than or equal to 200 nm. In addition, the thickness of the base film 210 is preferably less than or equal to 1 μm and further preferably less than or equal to 500 nm.

A material used for the base film 210 contains the same metal as a metal included in the positive electrode current collector layer 201. For example, titanium is used for the positive electrode current collector layer 201 and titanium nitride is used for the base film 210. In such a case, the positive electrode current collector layer 201 and the base film 210 can be formed using the same target. In other words, the positive electrode current collector layer 201 is formed by a sputtering method using a titanium target and a reactive sputtering method is used, whereby the base film 210 can be formed using the titanium target. When the positive electrode current collector layer 201 and the base film 210 are formed using the same target, the solid secondary battery can be easily manufactured, leading to a reduction in cost.

Next, the positive electrode active material layer 202 is formed over the base film 210. The positive electrode active material layer 202 can be formed by a sputtering method using a sputtering target including lithium cobalt oxide (LiCoO₂, LiCo₂O₄, or the like) as its main component, a sputtering target including a lithium manganese oxide (LiMnO₂, LiMn₂O₄, or the like) as its main component, or a lithium nickel oxide (LiNiO₂, LiNi₂O₄, or the like). A lithium manganese cobalt oxide (LiMnCoO₄, Li₂MnCoO₄, or the like), a ternary material of nickel-cobalt-manganese (LiNi_{1/3}Mn_{1/3}Co_{1/3}O₂: NCM), a ternary material of nickel-cobalt-aluminum (LiNi_{0.8}Co_{0.15}Al_{0.05}O₂: NCA), or the like can be used. Alternatively, the positive electrode active material layer 202 may be formed by a vacuum evaporation method. Note that in the solid-state secondary battery of one embodiment of the present invention, heteroepitaxial growth occurs during film growing (film deposition) of the positive electrode active material layer 202.

As described above, with a combination of materials of the base film 210 and the positive electrode active material layer 202, which satisfy that at least one of the values calculated by the formula (1) and the formula (2) is less than or equal to 0.1, the positive electrode active material layer 202 with favorable crystallinity can be formed.

The film deposition of the positive electrode active material layer 202 is preferably performed at high temperatures (higher than or equal to 500° C.). Alternatively, annealing treatment (at a temperature higher than or equal to 500° C.) is preferably performed after the positive electrode active material layer 202 is formed. With such a manufacturing method, the positive electrode active material layer 202 with further favorable crystallinity can be formed.

In the positive electrode where a metal is used for the positive electrode current collector layer 201, the metal of the positive electrode current collector layer 201 diffuses into the positive electrode active material layer 202 due to the above annealing treatment, which causes a degradation in charge and discharge characteristics in some cases. In other words, characteristics are degraded by the annealing treatment in some cases. Meanwhile in the positive electrode of the solid-state secondary battery of one embodiment of the present invention, the base film 210 is included between the positive electrode current collector layer 201 and the positive electrode active material layer 202. Thus, the metal of the positive electrode current collector layer 201 can be inhibited from diffusing into the positive electrode active material layer 202. In other words, the base film 210 serves as a diffusion prevention film. Therefore, the solid-state secondary battery of one embodiment of the present invention prevents an annealing-induced degradation in charge and discharge characteristics and enables enhancement of the crystallinity of the positive electrode active material layer 202.

Next, the solid electrolyte layer 203 is formed. Examples of materials for the solid electrolyte layer includes Li₃PO₄, LiₓPo_{(4-y)}Ny, Li_{0.35}La_{0.55}TiO₃, La_{(2/3-x)}Li₃ₓTiO₃, LiNb₍₁₋ₓ₎Ta₍ₓ₎WO₆, Li₇La₃Zr₂O₁₂, Li₍₁₊ₓ₎Al₍ₓ₎Ti₍₂₋ₓ₎(PO₄)₃, Li₍₁₊ₓ₎Al₍ₓ₎Ge₍₂₋ₓ₎(PO₄)₃, and LiNbO₂. Note that X>0 and Y>0. As a film formation method, a sputtering method, an evaporation method, or the like can be used. In addition, SiO_{X} (0<X≤2) can also be used for the solid electrolyte layer 203. SiO_{X} (0<X≤2) may be used for the solid electrolyte layer 203, and SiO_{X} (0<X≤2) may be used for the negative electrode active material layer 204. In this case, the ratio of oxygen to silicon (O/Si) in SiO_{X} is preferably higher in the solid electrolyte layer 203 than in the negative electrode active material layer 204. With this structure, conductive ions (particularly lithium ions) in the solid electrolyte layer 203 are likely to diffuse, and conductive ions (particularly lithium ions) in the negative electrode active material layer 204 are likely to be extracted or accumulated, whereby a solid-state secondary battery with favorable characteristics can be obtained. When the solid electrolyte layer 203 and the negative electrode active material layer 204 are formed using materials having the same composition as described above, whereby a solid-state secondary battery can be manufactured easily.

The solid electrolyte layer 203 may have a stacked-layer structure. In the case of a stacked-layer structure, a material to which nitrogen is added to lithium phosphate (Li₃PO₄) (the material is also referred to as Li₃PO_{(4-Z)}N_{Z}:LiPON) may be stacked as one layer. Note that Z>0.

Next, the negative electrode active material layer 204 is formed. The negative electrode active material layer 204 can be a film containing silicon as a main component, a film containing carbon as a main component, a titanium oxide film, a vanadium oxide film, an indium oxide film, a zinc oxide film, a tin oxide film, a nickel oxide film, or the like which is formed by a sputtering method or the like. A film of tin, gallium, aluminum, or the like which is alloyed with Li can be used. Alternatively, a metal oxide film of any of these which are alloyed with Li may be used. A Li metal film may also be used as the negative electrode active material layer 204. A lithium titanium oxide (Li₄Ti₅O₁₂, LiTi₂O₄, or the like) may be used; in particular, a film containing silicon and oxygen is preferable.

Next, the negative electrode current collector layer 205 is formed. As a material of the negative electrode current collector layer 205, one or more kinds of conductive materials selected from Al, Ti, Cu, Au, Cr, W, Mo, Ni, Ag, and the like is used. As a film formation method, a sputtering method, an evaporation method, or the like can be used. In a sputtering method, with use of a metal mask, film deposition can be selectively performed. A conductive film may be patterned by being selectively removed by dry etching or wet etching using a resist mask or the like.

In the case where the positive electrode current collector layer 201 or the negative electrode current collector layer 205 is formed by a sputtering method, at least one of the positive electrode active material layer 202 and the negative electrode active material layer 204 is preferably formed by a sputtering method. A sputtering apparatus is capable of successive film deposition in one chamber or using a plurality of chambers and can also be a multi-chamber manufacturing apparatus or an in-line manufacturing apparatus. A sputtering method is a manufacturing method suitable for mass production that uses a chamber and a sputtering target. In addition, a sputtering method enables thin formation and thus excels in a film deposition property.

For film deposition of each layer described in this embodiment, a gas phase method (a vacuum evaporation method, a thermal spraying method, a pulsed laser deposition method (a PLD method), an ion plating method, a cold spray method, or an aerosol deposition method) can also be used without limitation to a sputtering method. Note that an aerosol deposition (AD) method is a method in which deposition is performed without heating a substrate. The aerosol means microparticles dispersed in a gas. Alternatively, a CVD method or an ALD (Atomic layer Deposition) method may be used.

### Embodiment 3

Solid-state secondary batteries can be connected in series in order to increase the output voltage of the solid-state secondary batteries. An example of manufacturing solid-state secondary batteries connected in series will be described in this embodiment, whereas the example of the single-layer cell is described in Embodiment 1.

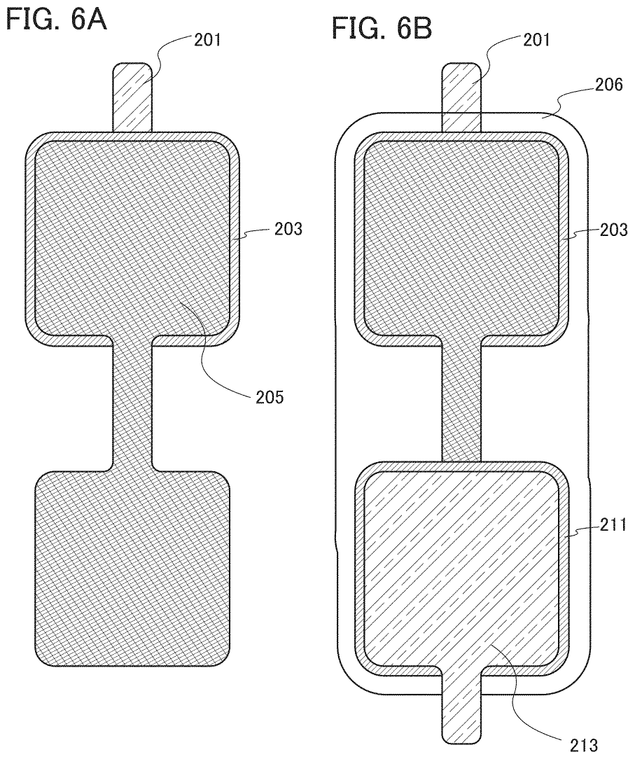

FIG. 6A is a top view right after formation of a first solid-state secondary battery, and FIG. 6B is a top view of two solid-state secondary batteries connected in series. In FIG. 6A and FIG. 6B, the same portions as the portions in FIG. 4A and FIG. 4B described in Embodiment 1 are denoted by the same reference numerals.

FIG. 6A illustrates the state right after formation of the negative electrode current collector layer 205. The shape of the top surface of the negative electrode current collector layer 205 is different from that in FIG. 4A. The negative electrode current collector layer 205 illustrated in FIG. 6A is partly in contact with a side surface of the solid electrolyte layer and is also in contact with an insulating surface of the substrate. This insulating surface is also in contact with the negative electrode of the first secondary battery.

Then, a second positive electrode active material layer is formed over a region which is in the negative electrode current collector layer 205 and does not overlap with a first negative electrode active material layer, as illustrated in FIG. 4B. Then, a second solid electrolyte layer 211 is formed, and a second base film, a second positive electrode active material layer, and a second positive electrode current collector 213 are formed thereover. Finally the protective layer 206 is formed.

FIG. 6B illustrates a structure in which two solid-state secondary batteries are arranged on a plane and connected in series.

### Embodiment 4

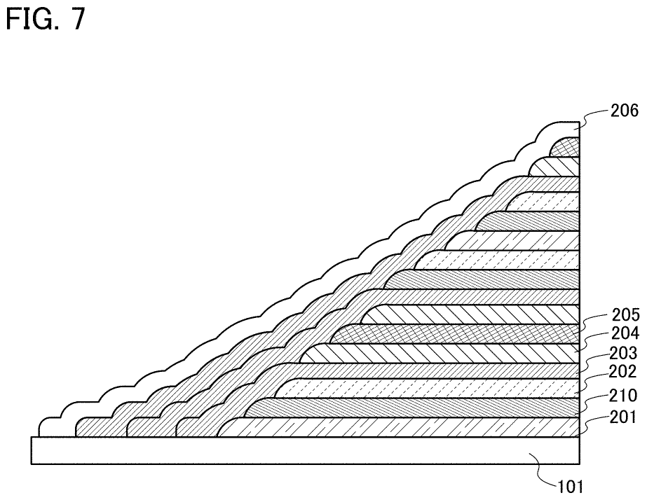

An example of a multi-layer cell will be described in this embodiment, whereas the example of the single-layer cell is described in Embodiment 1. FIG. 7 illustrates one of embodiments describing the case of a multi-layer cell of a thin-film-type solid-state secondary battery.

FIG. 7 illustrates an example of a cross section of a three-layer cell.

A first cell is formed in such a manner that the positive electrode current collector layer 201 is formed over the substrate 101, and the base film 210, the positive electrode active material layer 202, the solid electrolyte layer 203, the negative electrode active material layer 204, and the negative electrode current collector layer 205 are sequentially formed over the positive electrode current collector layer 201.

Furthermore, a second cell is formed in such a manner that a second negative electrode active material layer, a second solid electrolyte layer, a second base film, a second positive electrode active material layer, and a second positive electrode current collector layer are sequentially formed over the negative electrode current collector layer 205.

Moreover, a third cell is formed in such a manner that a third base film, a third positive electrode active material layer, a third solid electrolyte layer, a third negative electrode active material layer, and a third negative electrode current collector layer are sequentially formed over the second positive electrode current collector layer.

In the solid-state secondary battery of one embodiment of the present invention, the base film is introduced as a layer that is in contact with the positive electrode active material layer and on the substrate side, whereby the crystallinity of the positive electrode active material layer can be enhanced. Since there is not particular limitation on a position where the base film can be formed, the base film can be formed over the positive electrode current collector layer or the solid electrolyte layer as illustrated in FIG. 7. Thus, the present invention can be suitably used for a solid-state secondary battery with a multi-layer cell.

Lastly, the protection layer 206 is formed in FIG. 7. The three-layer stack illustrated in FIG. 7 has a structure of series connection in order to increase the capacity but can be connected in parallel with an external wiring. Series connection, parallel connection, or series-parallel connection can also be selected with an external wiring.

Note that the solid electrolyte layer 203, the second solid electrolyte layer, and the third solid electrolyte layer are preferably formed using the same material, leading to a reduction in the manufacturing cost.

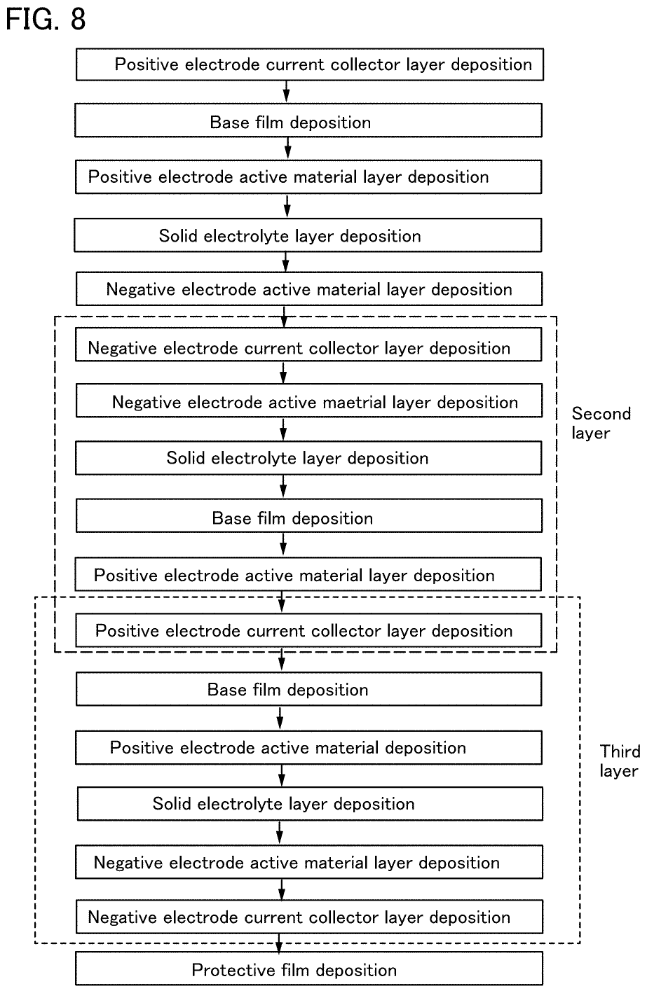

FIG. 8 shows an example of a manufacturing flow for obtaining the structure illustrated in FIG. 7.

To reduce the number of manufacturing steps, in FIG. 8, it is preferable to use a LCO film (a lithium cobalt oxide film (LiCoO₂)) for the positive electrode active material layer and to use a titanium film for the positive and negative electrode current collectors (conductive layer). The use of the titanium film as a common electrode allows a three-layer stacked cell with a small number of components to be achieved.

This embodiment can be combined with the other embodiments as appropriate.

### Embodiment 5

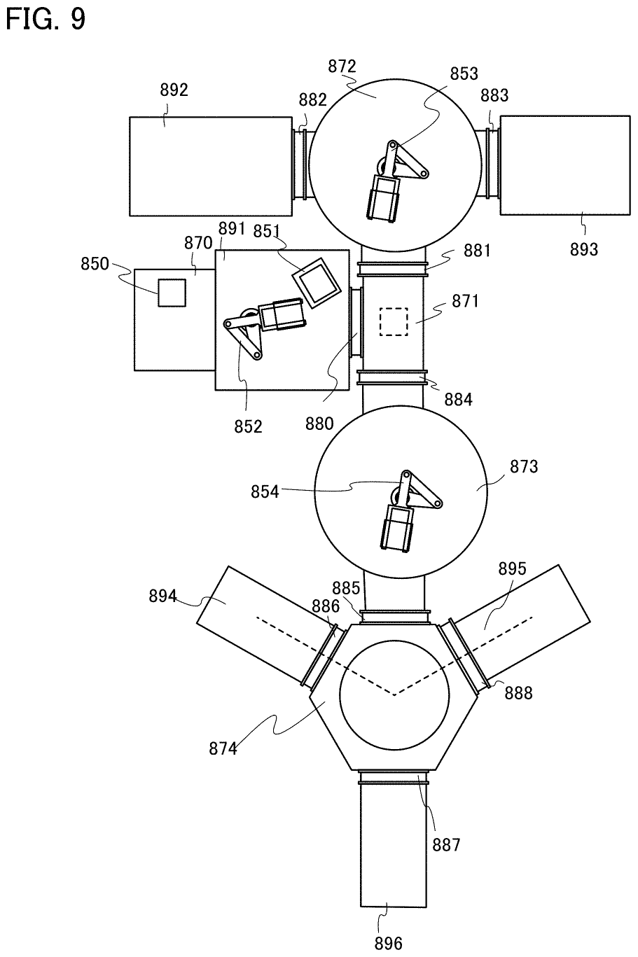

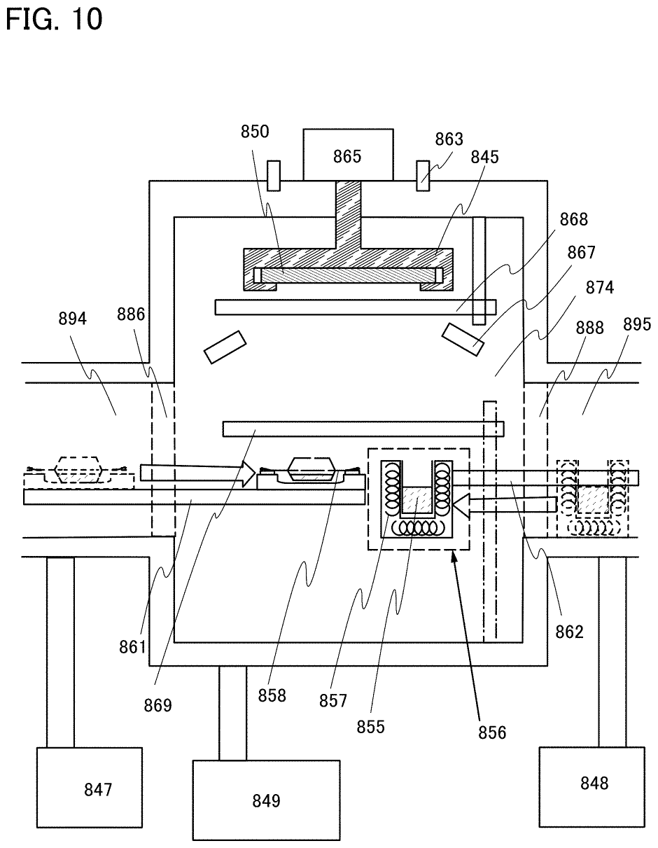

In this embodiment, FIG. 9 and FIG. 10 illustrate an example of a multi-chamber manufacturing apparatus capable of totally automating the manufacture from a positive electrode current collector layer to a negative electrode current collector layer in a secondary battery. The manufacturing apparatus can be suitably used for manufacturing the solid-state secondary battery of one embodiment of the present invention.

FIG. 9 illustrates an example of a multi-chamber manufacturing apparatus that includes gates 880, 881, 882, 883, 884, 885, 886, 887, and 888, a load lock chamber 870, a mask alignment chamber 891, a first transfer chamber 871, a second transfer chamber 872, a third transfer chamber 873, a plurality of deposition chambers (a first deposition chamber 892 and a second deposition chamber 874), a heating chamber 893, a second material supply chamber 894, a first material supply chamber 895, and a third material supply chamber 896.

The mask alignment chamber 891 includes at least a stage 851 and a substrate transfer mechanism 852.

The first transfer chamber 871 includes a substrate cassette raising and lowering mechanism, the second transfer chamber 872 includes a substrate transfer mechanism 853, and the third transfer chamber includes a substrate transfer mechanism 854.

Each of the first deposition chamber 892, the second deposition chamber 874, the second material supply chamber 894, the first material supply chamber 895, the third material supply chamber 896, the mask alignment chamber 891, the first transfer chamber 871, the second transfer chamber 872, and the third transfer chamber 873 is connected to an exhaust mechanism. The exhaust mechanism is selected in accordance with usage of the respective chambers, and may be, for example, an exhaust mechanism including a pump having an adsorption unit, such as a cryopump, a sputtering ion pump, or a titanium sublimation pump, an exhaust mechanism including a turbo molecular pump provided with a cold trap, or the like.

In a process of film deposition on the substrate, the substrate 850 or the substrate cassette is set in the load lock chamber 870, and transferred to the mask alignment chamber 891 by the substrate transfer mechanism 852. A mask to be used is picked up among a plurality of masks set in advance in the mask alignment chamber 891, and its position is aligned with the substrate over the stage 851. After the position alignment, the gate 880 is opened, and transferring to the first transfer chamber 871 is performed by the substrate transfer mechanism 852. After the substrate is transferred to the first transfer chamber 871, the gate 881 is opened, and transferring to the second transfer chamber 872 is performed by the substrate transfer mechanism 853.

The first deposition chamber 892 provided in the second transfer chamber 872 through the gate 882 is a sputtering deposition chamber. The sputtering deposition chamber has a mechanism of applying voltage to the sputtering target by switching an RF power supply and a pulsed DC power supply. Furthermore, two or three kinds of sputtering targets can be set. In this embodiment, a single crystal silicon target, a sputtering target containing lithium cobalt oxide (LiCoO₂) as a main component, and a titanium target are set. It is possible to provide a substrate heating mechanism in the first deposition chamber 892 and perform film deposition while heating is performed up to a heater temperature of 700° C.

The negative electrode active material layer can be formed by a sputtering method using a single crystal silicon target. An SiO_{X} film formed by a reactive sputtering method using an Ar gas and an O₂ gas may be used as the negative electrode active material layer in the negative electrode. A silicon nitride film formed by a reactive sputtering method using an Ar gas and an N₂ gas can be used as a sealing film. The positive electrode active material layer can be formed by a sputtering method using a sputtering target containing lithium cobalt oxide (LiCoO₂) as a main component. A conductive film to be a current collector can be formed by a sputtering method using a titanium target. A titanium nitride film formed by a reactive sputtering method using an Ar gas and an N₂ gas can be used as a diffusion prevention layer between the current collector layer and the active material layer.

In the case where the positive electrode active material layer is formed, the mask and the substrate in an overlapped state are transferred from the second transfer chamber 872 to the first deposition chamber 892 by the substrate transfer mechanism 853, the gate 882 is closed, and then film deposition is performed by a sputtering method. After the deposition, the gate 882 and the gate 883 are opened, transferring to the heating chamber 893 is performed, the gate 883 is closed, and then heating can be performed. For this heat treatment in the heating chamber 893, an RTA (Rapid Thermal Anneal) apparatus, a resistance heating furnace, or a microwave heating apparatus can be used. As the RTA apparatus, a GRTA (Gas Rapid Thermal Anneal) apparatus or an LRTA (Lamp Rapid Thermal Anneal) apparatus can be used. The heat treatment in the heating chamber 893 can be performed in an atmosphere of nitrogen, oxygen, a rare gas, or dry air. In addition, heating time is longer than or equal to 1 minute and shorter than or equal to 24 hours.

After the film deposition or the heat treatment, the substrate and the mask are returned to the mask alignment chamber 891 and position alignment for a new mask is performed. The substrate and the mask after being subjected to the position alignment are transferred to the first transfer chamber 871 by the substrate transfer mechanism 852. The substrate is transferred by the raising and lowering mechanism of the first transfer chamber 871, the gate 884 is opened, and transferring to the third transfer chamber 873 is performed by the substrate transfer mechanism 854.

In the second deposition chamber 874 which is connected to the third transfer chamber 873 through the gate 885, film deposition is performed by evaporation.

FIG. 10 illustrates an example of a cross-sectional structure of the second deposition chamber 874. FIG. 10 corresponds to a schematic cross-sectional view taken along the dotted line in FIG. 9. The second deposition chamber 874 is connected to the exhaust mechanism 849, and the first material supply chamber 895 is connected to the exhaust mechanism 848. The second material supply chamber 894 is connected to the exhaust mechanism 847. The second deposition chamber 874 illustrated in FIG. 10 is an evaporation chamber where evaporation is performed using an evaporation source 856 that is transferred from the first material supply chamber 895. Evaporation sources are transferred from a plurality of material supply chambers and evaporation by vaporizing a plurality of substances at the same time, that is, co-evaporation can be performed. FIG. 10 illustrates an evaporation source including an evaporation boat 858 transferred from the second material supply chamber 894.

The second deposition chamber 874 is connected to the second material supply chamber 894 through the gate 886. The second deposition chamber 874 is connected to the first material supply chamber 895 through the gate 888. The second deposition chamber 874 is connected to the third material supply chamber 896 through the gate 887. Thus, ternary co-evaporation is possible in the second deposition chamber 874.

In a process of evaporation, the substrate is provided in a substrate holding portion 845. The substrate holding portion 845 is connected to a rotation mechanism 865. Then, a first evaporation material 855 is heated to some extent in the first material supply chamber 895, the gate 888 is opened when the evaporation rate becomes stable, and an arm 862 is extended so that the evaporation source 856 is transferred and stopped below the substrate. The evaporation source 856 includes the first evaporation material 855, a heater 857, and a container for storing the first evaporation material 855. Also in the second material supply chamber 894, the second evaporation material is heated to some extent, the gate 886 is opened when the evaporation rate becomes stable, and an arm 861 is extended so that the evaporation source is transferred and stopped below the substrate.

After that, a shutter 868 and an evaporation source shutter 869 are opened, and co-evaporation is performed. During the evaporation, the rotation mechanism 865 is rotated in order to improve the uniformity of the thickness. The substrate after being subjected to the evaporation is transferred to the mask alignment chamber 891 on the same route. In the case where the substrate is extracted from the manufacturing apparatus, the substrate is transferred from the mask alignment chamber 891 to the load lock chamber 870 and extracted.

FIG. 10 illustrates an example where the substrate 850 and a mask are held by the substrate holding portion 845. The substrate 850 (and the mask) is rotated by a substrate rotation mechanism, so that uniformity of film deposition can be increased. The substrate rotation mechanism may also serve as a substrate transfer mechanism.

The second deposition chamber 874 may include an imaging unit 863 such as a CCD camera. With the provision of the imaging unit 863, the position of the substrate 850 can be confirmed.

In the second deposition chamber 874, the thickness of a film deposited on a substrate surface can be estimated from results of measurements by a film thickness measurement mechanism 867. The film thickness measurement mechanism 867 may include a crystal oscillator, for example.

The shutter 868 is provided so as to overlap with the substrate until the vaporization rate of the evaporation material becomes stable, and the evaporation source shutter 869 is provided to overlap with the evaporation source 856 and the evaporation boat 858 until the vaporization rate of the evaporation material becomes stable, in order to control the evaporation of the vaporized evaporation material.

In the evaporation source 856, an example of a resistance heating method is shown, but an EB (Electron Beam) evaporation method may be employed. In addition, although an example of a crucible as the container for the evaporation source 856 is shown, an evaporation boat may be used. As the first evaporation material 855, an organic material is put into the crucible heated by the heater 857. In the case where pellet-like or particle-like SiO or the like is used as the evaporation material, the evaporation boat 858 is used. The evaporation boat 858 is composed of three parts, and obtained by overlapping a member having a concave surface, a middle lid having two openings, and a top lid having one opening. Note that the evaporation may be performed after the middle lid is removed. The evaporation boat 858 functions as a resistor when current flows therethrough, and has a mechanism of heating itself.

Although an example of a multi-chamber apparatus is described in this embodiment, there is no particular limitation and an in-line manufacturing apparatus may be used.

### Embodiment 6

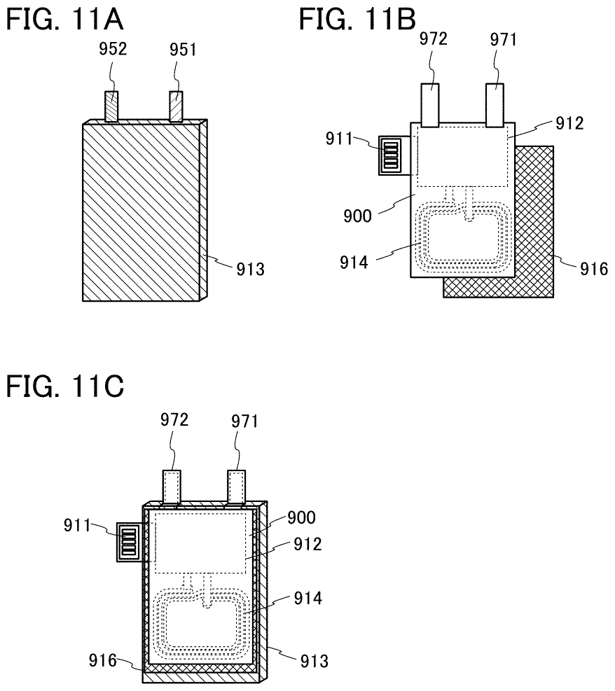

FIG. 11A is an external view of a thin-film-type solid-state secondary battery. The secondary battery 913 includes a terminal 951 and a terminal 952. The terminal 951 and the terminal 952 are electrically connected to a positive electrode and a negative electrode, respectively. The solid-state secondary battery of one embodiment of the present invention has excellent charge and discharge efficiency. In addition, the level of safety is high because of an all-solid-state secondary battery. Therefore, the secondary battery of one embodiment of the present invention can be suitably used as the secondary battery 913.

FIG. 11B is an external view of a battery control circuit. A battery control circuit shown in FIG. 11B includes a substrate 900 and a layer 916. A circuit 912 and an antenna 914 are provided over the substrate 900. The antenna 914 is electrically connected to the circuit 912. The terminal 971 and the terminal 972 are electrically connected to the circuit 912. The circuit 912 is electrically connected to the terminal 911.

The terminal 911 is connected to a device to which electric power of the thin-film-type solid-state secondary battery is supplied, for example. For example, the terminal 911 is connected to a display device, a sensor, or the like.

The layer 916 has a function of blocking an electromagnetic field from the secondary battery 913, for example. As the layer 916, for example, a magnetic body can be used.

FIG. 11C shows an example in which the battery control circuit shown in FIG. 11B is provided over the secondary battery 913. The terminal 971 and the terminal 972 are electrically connected to the terminal 951 and the terminal 952, respectively. The layer 916 is provided between the substrate 900 and the secondary battery 913.

A substrate having flexibility is preferably used as the substrate 900.

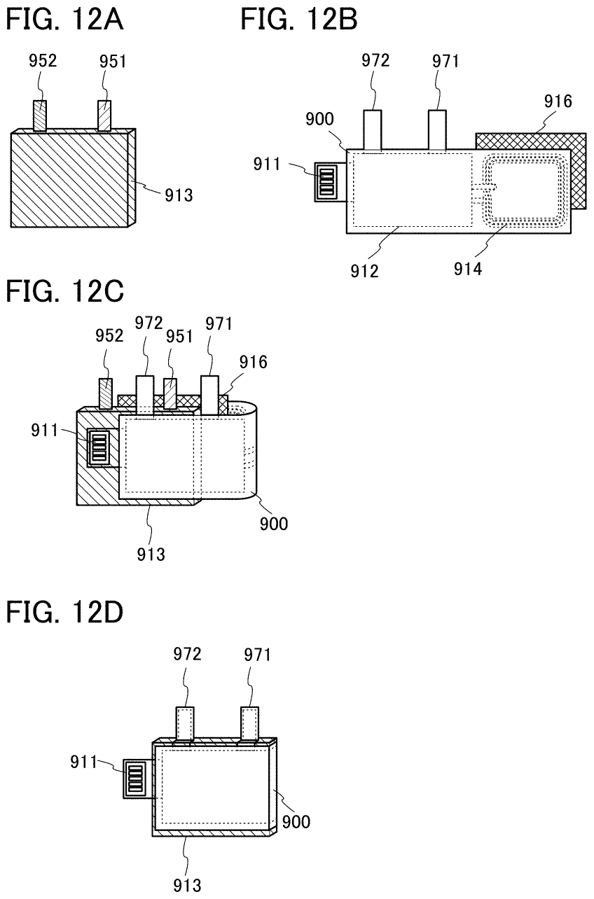

By using a substrate having flexibility as the substrate 900, a thin battery control circuit can be achieved. As illustrated in FIG. 12D described later, the battery control circuit can be wound around the secondary battery.

FIG. 12A is an external view of a thin-film-type solid-state secondary battery. A battery control circuit shown in FIG. 12B includes the substrate 900 and the layer 916.

As shown in FIG. 12C, the substrate 900 is bent to fit the shape of the secondary battery 913, and the battery control circuit is provided around the secondary battery, whereby the battery control circuit can be wound around the secondary battery as shown in FIG. 12D.

### Embodiment 7

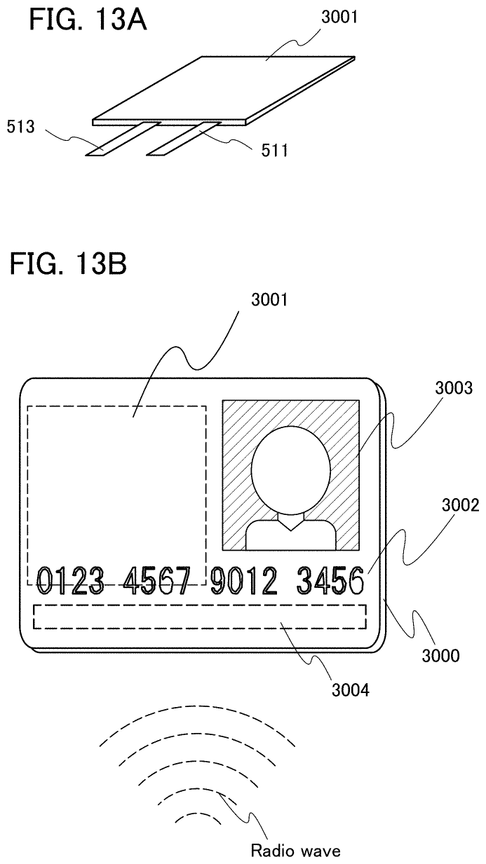

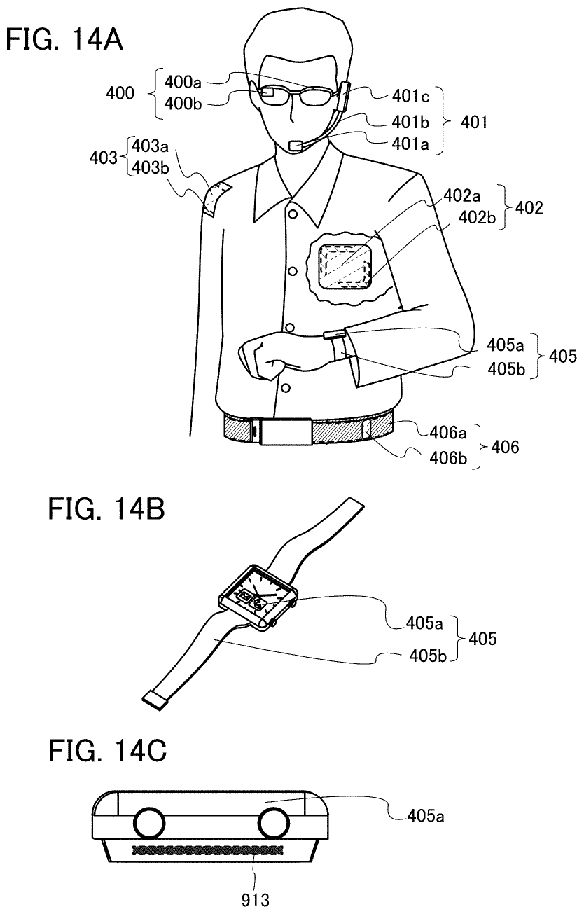

In this embodiment, examples of electronic devices using thin-film-type solid-state secondary batteries will be described with reference to FIG. 13A, FIG. 13B, FIG. 14A, FIG. 14B, and FIG. 14C. The thin-film-type solid-state secondary battery of one embodiment of the present invention has high discharge capacity, high discharge efficiency, and a high level of safety. Thus, the electronic devices ensure a high level of safety and can be used for a long time.

FIG. 13A is an external perspective view of a thin-film-type solid-state secondary battery 3001. The thin-film-type solid-state secondary battery 3001 is subjected to sealing with a laminate film or an insulating film such that a positive electrode lead electrode 513 electrically connected to a positive electrode of a solid-state secondary battery and a negative electrode lead electrode 511 electrically connected to a negative electrode.

FIG. 13B illustrates an IC card which is an example of an application device using a thin-film-type solid-state secondary battery of the present invention. The thin-film-type solid-state secondary battery 3001 can be charged with electric power obtained by power feeding from a radio wave. In an IC card 3000, an antenna, an IC 3004, and the thin-film-type solid-state secondary battery 3001 are provided. An ID 3002 and a photograph 3003 of a worker who wears the management badge are attached on the IC card 3000. A signal such as an authentication signal can be transmitted from the antenna using the electric power charged in the thin-film-type solid-state secondary battery 3001.

An active matrix display device may be provided instead of the photograph 3003. As examples of the active matrix display device, a reflective liquid crystal display device, an organic EL display device, electronic paper, or the like can be given. An image (a moving image or a still image) or time can be displayed on the active matrix display device. Electric power for the active matrix display device can be supplied from the thin-film-type solid-state secondary battery 3001.

A plastic substrate is used for the IC card, and thus an organic EL display device using a flexible substrate is preferable.

A solar cell may be provided instead of the photograph 3003. By irradiation with external light, light can be absorbed to generate electric power, and the thin-film-type solid-state secondary battery 3001 can be charged with the electric power.

Without limitation to the IC card, the thin-film-type solid-state secondary battery can be used for a power source of an in-vehicle wireless sensor, a secondary battery for a MEMS device, or the like.

FIG. 14A illustrates examples of wearable devices. A secondary battery is used as a power source of a wearable device. To have improved water resistance in daily use or outdoor use by a user, a wearable device is desirably capable of being charged wirelessly as well as being charged with a wire whose connector portion for connection is exposed.

For example, a thin-film-type solid-state secondary battery can be incorporated in a glasses-type device 400 as shown in FIG. 14A. The glasses-type device 400 includes a frame 400a and a display portion 400b. A secondary battery is incorporated in a temple of the frame 400a having a curved shape, whereby the glasses-type device 400 can be lightweight, have a well-balanced weight, and be used continuously for a long time. The solid-state secondary battery described in Embodiment 1 may be included, and thus a structure that can support space saving due to a reduction in the size of a housing can be achieved.

Furthermore, the secondary battery can be incorporated in a headset-type device 401. The headset-type device 401 includes at least a microphone portion 401a, a flexible pipe 401b, and an earphone portion 401c. The secondary battery can be provided in the flexible pipe 401b or the earphone portion 401c. The solid-state secondary battery described in Embodiment 1 may be included, and thus a structure that can support space saving due to a reduction in the size of a housing can be achieved.

The secondary battery can also be incorporated in a device 402 that can be directly attached to a human body. A secondary battery 402b can be provided in a thin housing 402a of the device 402. The solid-state secondary battery described in Embodiment 1 may be provided, and thus a structure that can support space saving due to a reduction in the size of a housing can be achieved.

The secondary battery can also be incorporated in a device 403 that can be attached to clothing. A secondary battery 403b can be provided in a thin housing 403a of the device 403. The solid-state secondary battery described in Embodiment 1 may be provided, and thus a structure that can support space saving due to a reduction in the size of a housing can be achieved.

Furthermore, the secondary battery can be incorporated in a belt-type device 406. The belt-type device 406 includes a belt portion 406a and a wireless power feeding and receiving portion 406b, and the secondary battery can be incorporated in the belt portion 406a. The solid-state secondary battery described in Embodiment 1 may be provided, and thus a structure that can support space saving due to a reduction in the size of a housing can be achieved.

The secondary battery can also be incorporated in a watch-type device 405. The watch-type device 405 includes a display portion 405a and a belt portion 405b, and the secondary battery can be provided in the display portion 405a or the belt portion 405b. The solid-state secondary battery described in Embodiment 4 may be provided, and thus a structure that can support space saving due to a reduction in the size of a housing can be achieved.

The display portion 405a can display various kinds of information such as reception information of an e-mail or an incoming call in addition to time.

Since the watch-type device 405 is a type of wearable device that is directly wrapped around an arm, a sensor that measures pulse, blood pressure, or the like of a user can be incorporated therein. Data on the exercise quantity and health of the user can be stored and used for health maintenance.

FIG. 14B shows a perspective view of the watch-type device 405 that is detached from an arm.

FIG. 14C shows a side view. FIG. 14C shows a state where the secondary battery 913 is incorporated inside. The secondary battery 913 is the secondary battery described in Embodiment 4. The secondary battery 913 is provided to overlap with the display portion 405a and is small and lightweight.

### Embodiment 8

A device described in this embodiment includes at least a biosensor and a solid-state secondary battery that supplies power to the biosensor, and can obtain various kinds of biological data using infrared light and visible light and make the memory store the data. Such biological data can be used for both user's personal authentication uses and health care uses. The solid-state secondary battery of one embodiment of the present invention has higher discharge capacity, high discharge efficiency, and a high level of safety. Thus, the device has a high level of safety and can be used for a long time.

The biosensor is a sensor for obtaining biological data and obtains biological data that can be used for health care uses. Examples of biological data include pulse waves, blood glucose levels, oxygen saturation levels, and neutral fat concentrations. The data is stored in the memory.

Furthermore, the device described in this embodiment is preferably provided with a unit for obtaining other biological data. Examples of such biological data include internal biological data such as an electrocardiogram, a blood pressure, and a body temperature and superficial biological data such as facial expression, a complexion, and a pupil. In addition, data on the number of steps taken, exercise intensity, a height difference in a movement, and a meal (e.g., calorie intake and nutrients) are important for health care. The use of a plurality of kinds of biological data and the like enables complex management of physical conditions, leading to not only daily health management but also early detection of injuries and diseases.

Blood pressure can be calculated from an electrocardiogram and a difference in timing of two pulsations of a pulse wave (a period of pulse wave propagation time), for example. A high blood pressure results in a short pulse wave propagation time, whereas a low blood pressure results in a long pulse wave propagation time. The body conditions of the user can be estimated from a relationship between the heart rate and the blood pressure that are calculated from the electrocardiogram and the pulse wave. For example, when both the heart rate and the blood pressure are high, it can be estimated that the user is nervous or excited, whereas when both the heart rate and the blood pressure are low, it can be estimated that the user is relaxed. When the state where the blood pressure is low and the heart rate is high is continued, the user might suffer from a heart disease or the like.

The user can check the biological data measured with the electronic device, one's own body conditions estimated on the basis of the data, and the like at any time; thus, health awareness is improved. This may inspire the user to reconsider the daily habits, for example, to avoid over-eating and over-drinking, get enough exercise, manage one's physical conditions, and have a medical examination at a medical institution as necessary.

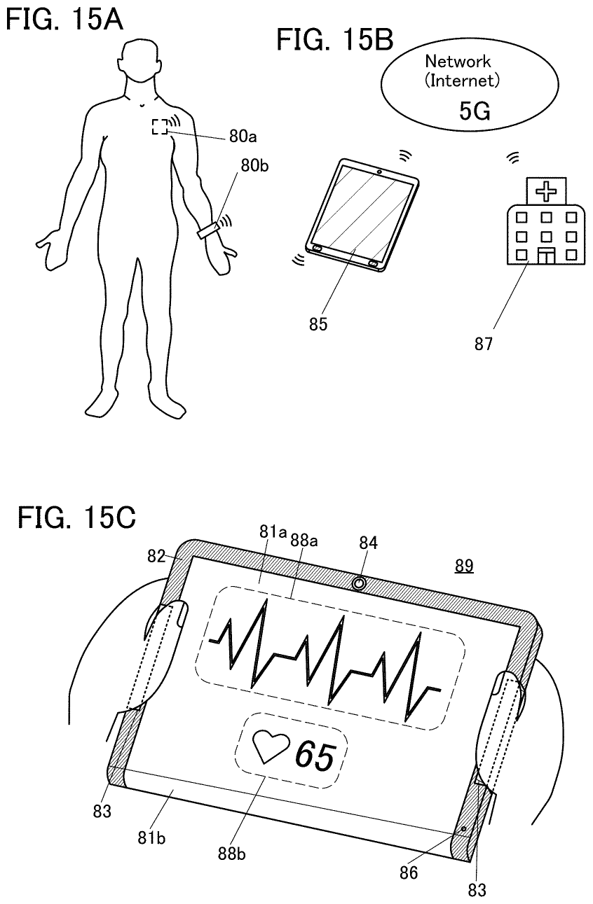

Data may be shared among a plurality of biosensors. FIG. 15A illustrates an example in which a biosensor 80a is embedded in a user's body and an example in which a biosensor 80b is worn on the user's wrist. Devices illustrated in FIG. 15A are, for example, a device including the biosensor 80a capable of electrocardiogram monitoring and a device including the biosensor 80b capable of heart rate monitoring by optically measurement of the pulse on the user's arm. Note that the wearable device such as a watch or a wristband illustrated in FIG. 15A is not limited to a heart rate meter, and a variety types of biosensors can be used.

As the predetermined conditions of the embedded device illustrated in FIG. 15A, the device is small, hardly generates heat, and causes no allergic reaction or the like even when the device is in contact with the user's skin. The secondary battery used in the device of one embodiment of the present invention is preferable because it is small, hardly generates heat, and causes no allergic reaction or the like. The embedded device preferably incorporates an antenna so as to enable wireless charging.

The device embedded into the living body, which is illustrated in FIG. 15A, is not limited to the biosensor capable of electrocardiogram monitoring, and a biosensor capable of obtaining other biological data can be used.

The biosensor 80b incorporated in the device may temporarily store data in a memory incorporated in the device. Alternatively, the data obtained by the biosensor may be transmitted to a portable data terminal 85 in FIG. 15B with or without a wire, and waveforms may be detected in the portable data terminal 85. The portable data terminal 85 corresponds to a smartphone or the like and can detect whether or not a problem such as an irregular heartbeat occurs from the data obtained from the biosensors. In the case where the data obtained by the plurality of biosensors are transmitted to the portable data terminal 85 with a wire, it is preferable that data obtained by connection with a wire be collectively transmitted. Note that date may be automatically given to the detected data, and the data may be stored in a memory of the portable data terminal 85 and managed personally. Alternatively, the data may be transmitted to a medical institution 87 such as a hospital via a network (including the Internet) as illustrated in FIG. 15B. The data can be managed in a data server of the hospital and used as inspection data in treatment. Since medical data sometimes swells to a huge amount of data, an network including Bluetooth (registered trademark) and a frequency band from 2.4 GHz to 2.4835 GHz may be used for the high-speed data communication between the biosensor 80b and the portable data terminal 85, and the fifth-generation (5G) wireless system may be used for the high-speed data communication between the portable data terminals 85. For the fifth-generation (5G) wireless system, frequency bands of the 3.7 GHz band, the 4.5 GHz band, and the 28 GHz band are used. With use of the fifth-generation (5G) wireless system, it becomes possible to obtain data and transmit the data to the medical institution 87, not only from home but also from the outside. As a result, data on poor physical conditions of the user can be accurately obtained and can be utilized for treatment performed later. Note that the portable data terminal 85 can have a structure illustrated in FIG. 15C.

FIG. 15C illustrates another example of a portable data terminal. A portable data terminal 89 includes a speaker, a pair of electrodes 83, a camera 84, and a microphone 86, in addition to a secondary battery.

The pair of electrodes 83 is provided in parts of a housing 82 with a display portion 81a therebetween. A display portion 81b is a curved region. The electrodes 83 function as electrodes for obtaining an electrocardiogram.

Providing the pair of electrodes 83 in the longitudinal direction of the housing 82 as illustrated in FIG. 15C enables an electrocardiogram to be obtained with the user being unconscious when the user uses the portable data terminal 89 with a landscape screen.

An example of the usage state of the portable data terminal 89 is illustrated. The display portion 81a can display electrocardiogram data 88a and heart-rate data 88b, which are obtained with the pair of electrodes 83.

This function is not necessary when the biosensor 80a is embedded in the user's body as illustrated in FIG. 15A. In contrast, when the biosensor 80a is not embedded, the user grasps the pair of electrodes 83 with the user's both hands, so that the electrocardiogram can be obtained. Even when the biosensor 80a is embedded in the user's body, the portable data terminal 89 illustrated in FIG. 15C can be used for comparing the electrocardiogram data with another user's in order to check whether the biosensor 80a operates normally.

The camera 84 can capture an image of the user's face, for example. Biological data on facial expression, a pupil, complexion, and the like can be obtained from the image of the user's face.

The microphone 86 can obtain the user's voice. Voiceprint data that can be used for voiceprint authentication can be obtained from the obtained voice data. When voice data is regularly obtained and a change in voice quality is monitored, the voice data can be utilized for health management. Needless to say, talking on a video call with a doctor at the medical institution 87 is possible with use of the microphone 86, the camera 84, and the speaker.

With use of the device illustrated in FIG. 15A and the portable data terminal 89 illustrated in FIG. 15C, a remote medical support system can be achieved, in which data is transmitted to a hospital in a remote area to see a doctor.

### Example 1

The crystallinity of a base film and that of a positive electrode active material in a solid-state secondary battery of one embodiment of the present invention will be described. Samples were fabricated by a sputtering method in a chamber at 600° C. Table 1 shows structures and fabrication conditions of the samples.

TABLE 1

| | Substrate/positive electrode | TiN | LiCoO₂ |
|---|---|---|---|
| | current collector layer | (nm) | (nm) |
| Comparison sample 1 | Ti sheet | 0 | 1000 |
| Sample 2 | Ti sheet | 20 | 1000 |
| Sample 3 | Ti sheet | 40 | 1000 |

### <Fabrication of Comparison Sample 1>

Over a titanium sheet, LiCoO₂ was deposited to a thickness of 1000 nm. A comparison sample 1 differs from a sample 2 and a sample 3 described later only in the absence of a base film.

### <Fabrication of Sample 2 and Sample 3>

Over a 100-μm-thick titanium sheet, TiN was deposited, and LiCoO₂ was deposited to a thickness of 1000 nm over the TiN. The TiN in the sample 2 was deposited to a thickness of 20 nm, and that in the sample 3 was deposited to a thickness of 40 nm. In the solid-state secondary battery, the titanium sheet serves as a substrate and a positive electrode current collector layer, the TiN serves as a base film, and the LiCoO₂ serves as a positive electrode active material. With use of TiN and LiCoO₂ for the base film and the positive electrode active material layer, respectively, as described above, the value calculated by the above formula (1) is approximately 0.06.

### <Evaluation of Crystallinity in Each Sample>

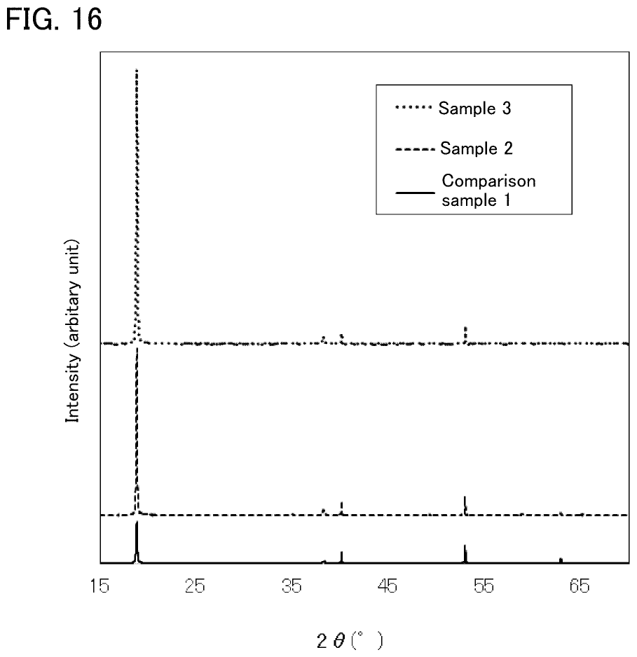

For evaluation of the crystallinity in each sample, XRD (X-ray diffraction) measurement was performed. With use of D8 ADVANCE produced by BRUKER as a measurement apparatus, the measurement was performed at room temperature. FIG. 16 shows the results.

In comparison of the half width of the peak appearing around 19° derived from the (003) of LiCoO₂ between the samples as shown in FIG. 16, it was found that the comparison sample 1 exhibits 0.137°, the sample 2 exhibits 0.125°, and the sample 3 exhibits 0.120°. In this specification, the sample exhibiting a smaller half width of the peak in the XRD measurement is evaluated as having higher crystallinity. In other words, it was revealed that the sample 2 and the sample 3 have higher crystallinity than the comparison sample 1. Consequently, introduction of the base film enables the crystallinity of the positive electrode active material layer to be enhanced. Furthermore, the sample 3 can be regarded as having higher crystallinity than the sample 2. Thus, as compared to the 20-nm-thick base film, the 40-nm-thick base film makes the crystallinity of LiCoO₂ higher. The conceivable reason is that a thicker TiN film facilitates an increase in its crystallinity, which makes it easy to generate the (003) in LiCoO₂ deposited over the (111) of the TiN.

### <Fabrication of Battery Cell>

Next, with use of the samples as positive electrodes, CR2032 type coin battery cells (a diameter of 20 mm, a height of 3.2 mm) were fabricated.

A lithium metal was used for a counter electrode.

As an electrolyte contained in an electrolyte solution, 1 mol/L of lithium hexafluorophosphate (LiPF₆) was used. As the electrolyte solution, a solution in which ethylene carbonate (EC) and diethyl carbonate (DEC) were mixed at EC:DEC=3:7 (volume ratio) was used. Note that for secondary batteries used for evaluating the charge and discharge efficiency, 2 wt % of vinylene carbonate (VC) was added to the electrolytic solution.

As a separator, 25-μm-thick polypropylene was used.

A positive electrode can and a negative electrode can that were formed using stainless steel (SUS) were used.

### <Measurement of Charge and Discharge Efficiency>

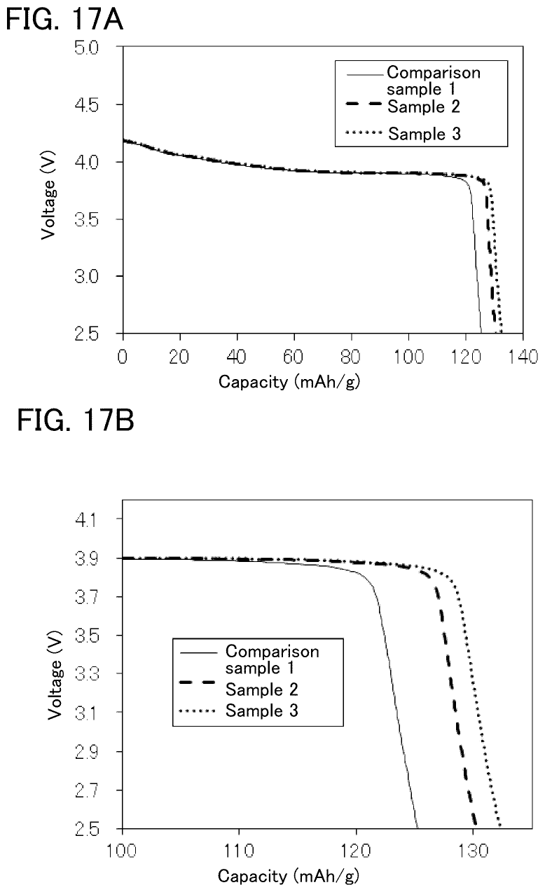

The initial characteristics were measured under conditions of CCCV charging, 0.2 C, 4.2 V, and a cutoff current of 0.1 C. Lithium-ion secondary batteries are generally charged by the CCCV charging method. CCCV charging is a charging method in which CC charging is performed until the voltage reaches a predetermined voltage and then CV charging is performed until the amount of current flow becomes small, specifically, a termination current value. One charging period is separated to a CC charging period (also referred to as CC time) and a following CV charging period (CV time). In the CC charging period, a constant current flows through a secondary battery until a predetermined voltage is reached, and in the CV charging period, charging is performed with a constant voltage until a termination current value is reached. In this example, discharging was performed at 0.2 C with a cutoff voltage of 2.5 V. Note that here, 1 C was set to 137 mA/g, which was a current value per weight of the positive electrode active material. The measurement temperature was set at 25° C. The measurement results of the initial characteristics are shown in Table 2, FIG. 17A and FIG. 17B. Note that FIG. 17B shows an enlarged portion in FIG. 17A where the capacity is over 100 (mAh/g).

TABLE 2

| | Discharge | Initial charge and discharge |
|---|---|---|
| | capacity (mAh/g) | efficiency (%) |
| Comparison sample 1 | 125 | 93.1 |
| Sample 2 | 130 | 94.8 |
| Sample 3 | 132 | 95.2 |

According to Table 2, FIG. 17A, and FIG. 17B, the sample 2 and the sample 3 exhibit higher discharge capacity and higher charge and discharge efficiency than the comparison sample 1. In addition, the sample 3 exhibits higher discharge capacity and higher charge and discharge efficiency than the sample 2. The results are attributed to higher LiCoO₂ crystallinity in the sample 2 than in the comparison sample 1 and higher LiCoO₂ crystallinity in the sample 3 than in the sample 2. In the case of focusing on a region greater than or equal to 0 (mAh/g) and less than or equal to 100 (mAh/g) in FIG. 17A, voltages in the samples are substantially equal to each other. This means that the battery characteristics are not adversely affected even when the base film, TiN, is introduced between the Ti sheet and the LiCoO₂. In other words, TiN is found to be a material having favorable conductivity.

Therefore, it was found that a secondary battery with favorable charge and discharge characteristics can be manufactured by introduction of a base film. Furthermore, it was found that the thickness of 40 nm is preferred to the thickness of 20 nm for the base film.

### REFERENCE NUMERALS

101: substrate, 150: solid-state secondary battery, 152: solid-state secondary battery, 154: solid-state secondary battery, 156: solid-state secondary battery, 158: solid-state secondary battery, 200: single-layer cell, 201: positive electrode current collector layer, 202: positive electrode active material layer, 203: solid electrolyte layer, 204: negative electrode active material layer, 205: negative electrode current collector layer, 206: protective layer, 210: base film, 211: solid electrolyte layer, 212: positive electrode current collector layer, 213: positive electrode current collector, 214: positive electrode current collector layer, 216: positive electrode current collector layer, 400: glasses-type device, 400a: frame, 400b: display portion, 401: headset-type device, 401a: microphone portion, 401b: flexible pipe, 401c: earphone portion, 402: device, 402a: housing, 402b: secondary battery, 403: device, 403a: housing, 403b: secondary battery, 405: watch-type device, 405a: display portion, 405b: belt portion, 406: belt-type device, 406a: belt portion, 406b: wireless power feeding and receiving portion, 511: negative electrode lead electrode, 513: positive electrode lead electrode, 845: substrate holding portion, 847: exhaust mechanism, 848: exhaust mechanism, 849: exhaust mechanism, 850: substrate, 851: stage, 852: substrate transfer mechanism, 853: substrate transfer mechanism, 854: substrate transfer mechanism, 855: evaporation material, 856: evaporation source, 857: heater, 858: evaporation boat, 861: arm, 862: arm, 863: imaging unit, 865: rotation mechanism, 867: film thickness measurement mechanism, 868: shutter, 869: evaporation source shutter, 870: load lock chamber, 871: transfer chamber, 872: transfer chamber, 873: transfer chamber, 874: deposition chamber, 880: gate, 881: gate, 882: gate, 883: gate, 884: gate, 885: gate, 886: gate, 887: gate, 888: gate, 891: mask alignment chamber, 892: deposition chamber, 893: heating chamber, 894: material supply chamber, 895: material supply chamber, 896: material supply chamber, 900: substrate, 911: terminal, 912: circuit, 913: secondary battery, 914: antenna, 916: layer, 951: terminal, 952: terminal, 971: terminal, 972: terminal, 3000: IC card, 3001: thin-film-type secondary battery, 3002: ID, 3003: photograph, 3004: IC

1. A solid-state secondary battery comprising:
a first layer over a substrate; and
a positive electrode active material layer over and in contact with the first layer,
wherein each of the substrate and the first layer has conductivity,
wherein the first layer is a film of a first material having a first crystal structure comprising first cations and first anions,
wherein the positive electrode active material layer is a film of a second material having a second crystal structure comprising second cations and second anions,
wherein a value calculated by a formula (1) is less than or equal to 0.1,
$$\begin{matrix}[ Formula 1 ] & \\ \frac{\vert La - Lb \vert}{L a} & ( 1 )\end{matrix}$$
wherein La denotes a minimum value of a distance between one of the first cations and another one of the first cations in the first crystal structure, and
wherein Lb denotes a minimum value of a distance between one of the second cations and another one of the second cations in the second crystal structure.

2. (canceled)

3. The solid-state secondary battery according to claim 1, wherein the second cations comprise a transition metal atom.

4. The solid-state secondary battery according to claim 1,
wherein a minimum angle formed by one of the first cations and two of the first anions is greater than or equal to 85° and less than or equal to 90°, and
wherein a minimum angle formed by one of the second cations and two of the second anions is greater than or equal to 85° and less than or equal to 90°.

5. The solid-state secondary battery according to claim 1,
wherein the first crystal structure is a rock-salt crystal structure, and
wherein the second crystal structure is a layered rock-salt crystal structure.

6. The solid-state secondary battery according to claim 1, wherein the substrate and the first layer comprise a same metal element.

7. The solid-state secondary battery according to claim 1, further comprising a positive electrode current collector layer between the substrate and the first layer.

8. The solid-state secondary battery according to claim 7, wherein the positive electrode current collector layer and the first layer comprise a same metal element.

9. The solid-state secondary battery according to claim 1, wherein the positive electrode active material layer comprises a lithium cobaltate.

10. The solid-state secondary battery according to claim 1, wherein the first layer comprises a titanium nitride.

11. The solid-state secondary battery according to claim 1, wherein the positive electrode active material layer is a deposition film.

12. A solid-state secondary battery comprising:
a first layer over a substrate; and
a positive electrode active material layer over and in contact with the first layer,
wherein the first layer and the positive electrode active material layer are in contact with each other,
wherein each of the substrate and the first layer has conductivity,
wherein the first layer is a film of a first material having a first crystal structure comprising first cations and first anions,
wherein the positive electrode active material layer is a film of a second material having a second crystal structure comprising second cations and second anions,
wherein a value calculated by a formula (2) is less than or equal to 0.1,
$$\begin{matrix}[ Formula 2 ] & \\ \frac{\vert la - lb \vert}{la} & ( 2 )\end{matrix}$$
wherein la denotes a minimum value of a distance between one of the first anions and another one of the first anions in the first crystal structure, and
wherein lb denotes a minimum value of a distance between one of the second anions and another one of the second anions in the second crystal structure.

13. The solid-state secondary battery according to claim 12 wherein the second cations comprises a transition metal atom.

14. The solid-state secondary battery according to claim 12,
wherein a minimum angle formed by one of the first cations and two of the first anions is greater than or equal to 85° and less than or equal to 90°, and
wherein a minimum angle formed by one of the second cations and two of the second anions is greater than or equal to 85° and less than or equal to 90°.

15. The solid-state secondary battery according to claim 12,
wherein the first crystal structure is a rock-salt crystal structure, and
wherein the second crystal structure is a layered rock-salt crystal structure.

16. The solid-state secondary battery according to claim 12, wherein the substrate and the first layer comprise a same metal element.

17. The solid-state secondary battery according to claim 12, wherein the positive electrode active material layer comprises a lithium cobaltate.

18. The solid-state secondary battery according to claim 12, wherein the first layer comprises a titanium nitride.

19. The solid-state secondary battery according to claim 12, wherein the positive electrode active material layer is a deposition film.
